(19) United States
(12) Patent Application Publication
(10) Pub. No.: US 2011/0165340 A1
(43) Pub. Date: Jul. 7, 2011

(54) DEVICE FOR GENERATIVELY MANUFACTURING A THREE-DIMENSIONAL OBJECT WITH CONTINUOUS HEAT SUPPLY

(75) Inventor: Andreas Baumann, Grafelfing (DE)

(73) Assignee: EOS GmbH Electro Optical Systems, Krailling (DE)

(21) Appl. No.: 12/984,033

(22) Filed: Jan. 4, 2011

(30) Foreign Application Priority Data
Jan. 5, 2010 (DE) 10 2010 004 036.3

(51) Int. Cl. B05D 3/06; B05C 9/08; B05D 3/02

(52) U.S. Cl. 427/532; 118/620; 118/641

(57) ABSTRACT

A device for generatively manufacturing a three-dimensional object (3) is disclosed, comprising: a frame (1), the upper portion (2) thereof surrounds a building field (6); a support (5) which is arranged in the frame (1) and vertically movable at least below the building field (6) by a lift mechanics (4); a radiation device (7) which generates an energetic beam (8, 8′) which is focused to arbitrary points in the building field (6) by a deflection means (9), so as to selectively sinter or melt a powdery material (11) which is present in the building field (6); a coater (10) for applying a layer of a powdery material (11) onto the support (5) or a previously applied layer of the powdery material (11); a housing (100), in which at least the frame (1) and the support (5) are arranged and which surrounds a building space; and a heating device (13; 14; 15; 16) which continuously supplies heat at least to the building field environment or the building space there above.

The present invention relates to a device for generatively manufacturing a three-dimensional object.

EP 0 764 079 B1 describes a known laser sintering device comprising a container which surrounds at the upper periphery thereof a building field; a support which is arranged in the container and vertically movable by a lift mechanics at least below the building field; a radiation device which generates an energetic beam which is focused to arbitrary points in the building field by a deflection means so as to selectively sinter or melt a powdery material which is present in the building field; and a coater for applying a layer of a powdery material onto the support or a previously applied layer of the powdery material. The laser sintering device has a heating means which serves to heat-up a powdery layer, which has been applied by a coater, to a pre-temperature which is required for the sintering process by means of the laser beam. The heating means in EP 0 764 079 B1 has a sensor in the shape of a pyrometer which is attached at a predetermined location above the powder bed and/or the building field. The temperature signals of the pyrometer are used as an actual value for a PID- or PI-feedback control.

Although the heating means is used, temperature inhomogeneities may occur within the building field, whereby the mechanical properties of the objects may be inhomogeneous.

It is the object of the present invention to provide a device for generatively manufacturing a three-dimensional object, by which the mechanical properties of the object to be manufactured can be improved.

This object is achieved by the device for generatively manufacturing a three-dimensional object having the features of claim 1. Advantageous further developments are subject of the dependent claims.

In an advantageous further development, the continuous heat loss is compensated by the continuous heat supply, for example, such that heat losses at the periphery of the building field can be minimized and a better temperature distribution is enabled up to the peripheral area. Thereby, the process-safe effective building field is enlarged, and homogenous heat supply and temperature distribution over the whole building field can be achieved.

Further features and aims of the invention can be gathered from the description of embodiments on the basis of the enclosed figures. In the figures show:

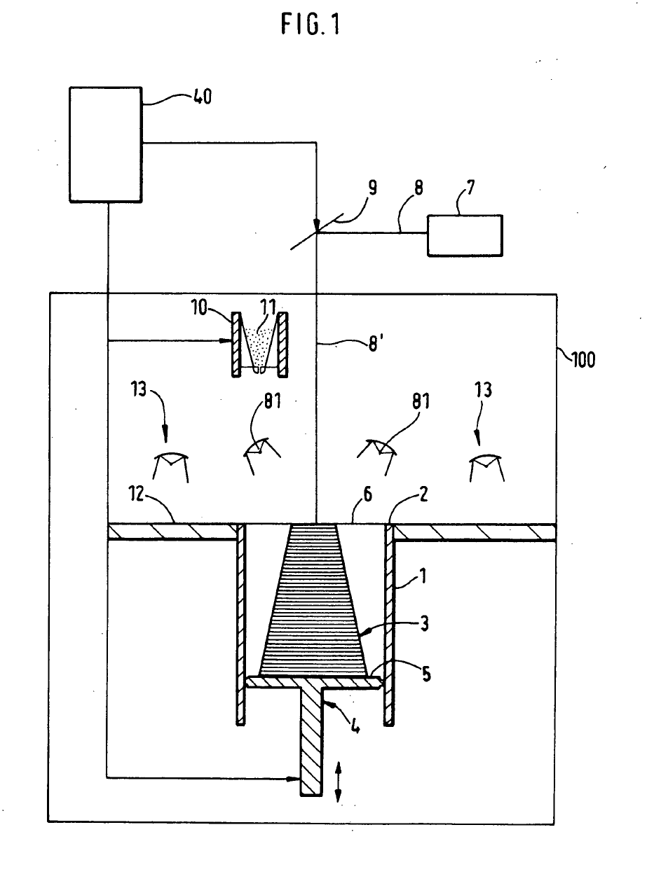

FIG. 1 a schematic view of a device for manufacturing a three-dimensional object according to a first embodiment of the present invention; and

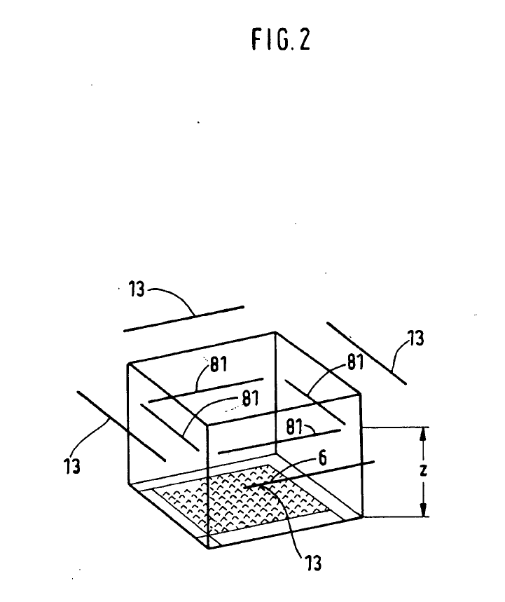

FIG. 2 a configuration of a heating device in the device according to FIG. 1;

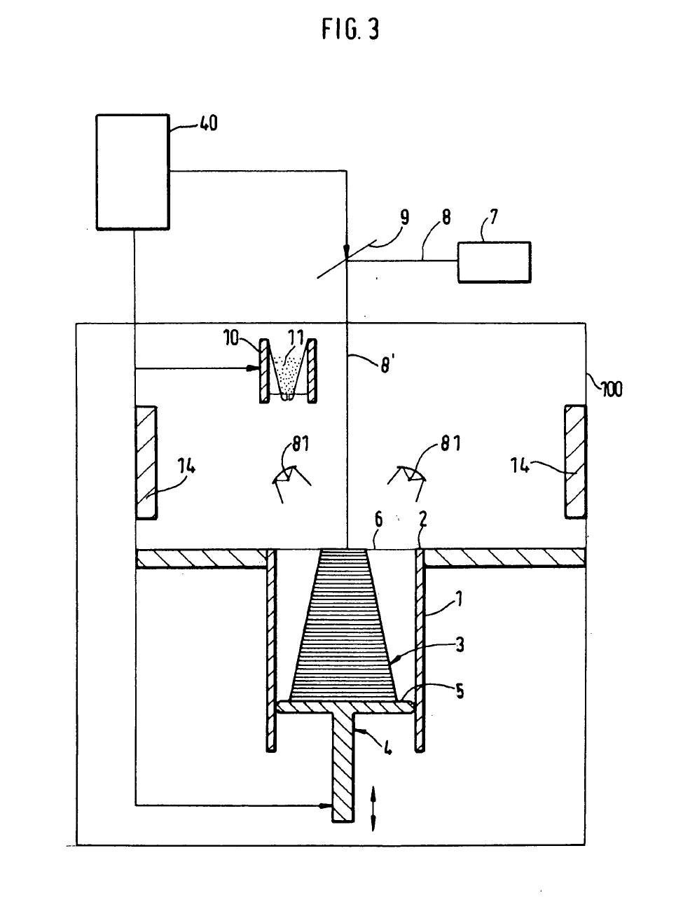

FIG. 3 a schematic view of a device for manufacturing a three-dimensional object according to a second embodiment of the present invention;

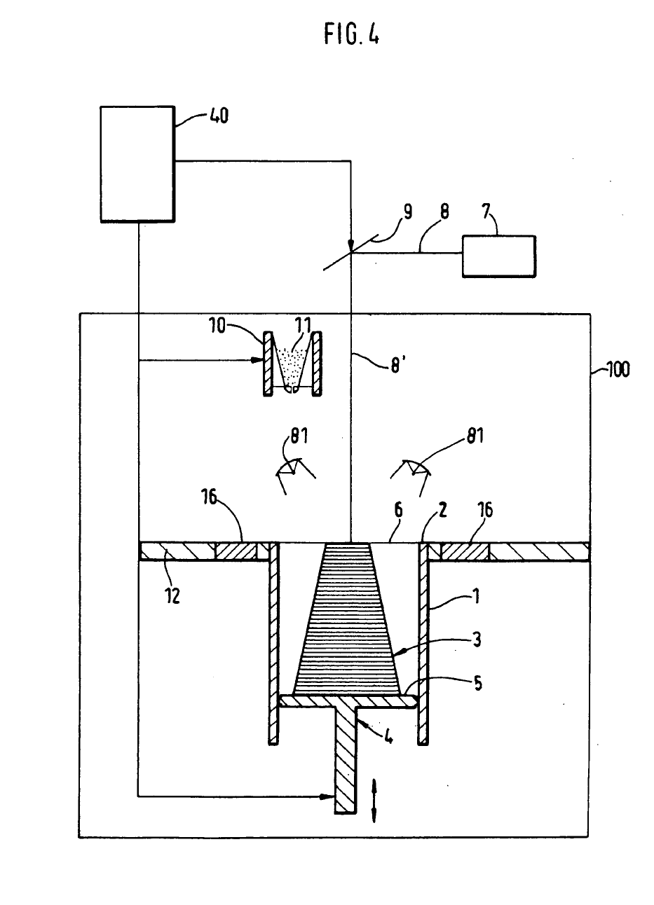

FIG. 4 a schematic view of a device for manufacturing a three-dimensional object according to a third embodiment of the present invention; and

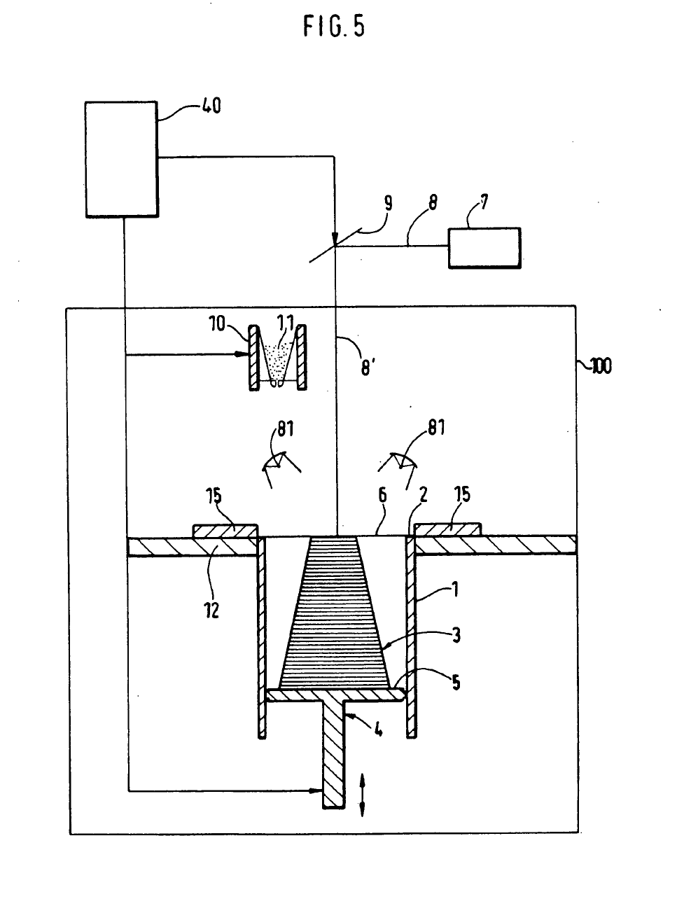

FIG. 5 a schematic view of a device for manufacturing a three-dimensional object according to a fourth embodiment of the present invention.

FIG. 1 shows a schematic view of a device for manufacturing a three-dimensional object 3 according to a first embodiment of the present invention which is exemplarily embodied as laser sintering device.

The laser sintering device comprises a frame 1 which opens at the top and includes therein a support 5 which is movable in the vertical direction and supports the three-dimensional object 3 to be manufactured. The frame 1 surrounds at the upper portion 2 thereof a building field 6. Preferably, the frame 1 and the support 5 form an exchangeable replacement frame which can be removed from the laser sintering device.

The support 5 is connected to a lift mechanics 4 which moves it in the vertical direction at least below the plane of the building field 6, so that the upper side of the powder layer, which is actually to be solidified, lies in the plane of the building field 6. As the plane of the building field, that plane is considered here, in which the upper periphery of the upper portion 2 is located.

Further, a coater 10 for applying a layer of a powdery material 11 is provided. As powdery material 11, all laser sinterable powders can be used, such as laser-sinterable polymers such as polyaryleetherketone, polyarylethersulfane, polyamide, polyester, polyether, polyolefine, polystyrene, polyphenylensulfide, polyvinylidenfluoride, polyphenylenoxyde, polyimide, their copolymers and blends which include at least one of the preceding polymers; however the selection is not restricted to the above-mentioned polymer and copolymer. Polyaryleetherketone, which are particularly suitable, can be selected from the group of polyetheretherketone (PEEK), polyetherketoneketone (PEKK), polyetherketone (PEK), polyetheretherketoneeketone (PEEKK) and polyetherketoneetherketoneeketone (PEKEKK) and polyetheretheretherketone (PEEEK) as well as their copolymers, in particular with polyurylethersulfone as well as their blends thereof can be selected which includes at least one of the above-mentioned polymers. Polyamide-polymer or copolymer and the blends thereof, which are particularly suitable, can be selected from the group which consists of polyamide 6/6T, polyamideelastomere such as polyetherblockamide such as PEBAX-based materials, polyamide 6, polyamide 66, polyamide 11, polyamide 12, polyamide 612, polyamide 610, polyamide 1010, polyamide 1212, polyamide PA6T/66, PA4T/46 and copolymers which include at least one of the above-mentioned polymers. Suitable polyester polymer or copolymer can be selected from polyalkylentererephtholate (for example PET, PBT) and their copolymers. Suitable polyolefinepolymere or copolymer can be selected from a group of consisting of polyethylene and polypropylene. Suitable polystyrenepolymer or copolymer can be selected from a group consisting of syndiotactic and isotactic polysterene. Further, compound powder of polymer can be used which include fillers and/or additives in addition to the corresponding polymer, copolymer or blend. Such fillers are for example fibers, such as coal or glass-fibers and carbon-nano tubes, fillers having a low aspect ratio such as glass-beads or aluminum grains, mineral fillers, such as titan dioxide. The additives can be, amongst others, process assisting means such as ripple-assisting means of the aerosol-series (such as Aerosil 200), functional additives such as heat stabilisators, oxidation stabilisators, color pigments (such as graphite and soot) and fire-proof means (such as organophosphate, polybromeneated hydrocarbon). As powdery material 11, also metals, ceramics, molding sand and compound materials can be used. As metal-containing powdery material, arbitrary metals and their alloys as well as mixtures of metallic components or non-metallic components can be considered.

The coater 10 is moved to a predetermined height above the building field 6, so that the layer of the powdery material 11 lies above the support 5 and/or above the last solidified layer by a predetermined height. The device further comprises a radiation device in the shape of a laser 7 which generates a laser beam 8, 8′ which is focused to arbitrary points in the building field 6 by a deflection means 9. Thereby, the laser beam 8, 8′ can selectively solidify the powdery material 11 at the locations corresponding to the cross-section of the object 3 to be manufactured.

Reference sign 100 designates a housing, in which the frame 1, the support 5 and the coater 10 are arranged. The housing 100 has in the upper area an inlet for the laser beam 8, 8′.

Preferably, the housing 100 is gas-tight formed, so that an inert gas can be introduced. In the following, the inside of the housing 100 is termed as building space. Further, a control unit 40 is provided, by which the device is controlled in a coordinated manner to perform the building process and to control the application of energy by the laser 7.

In the device, a plate 12 is provided, with which the frame 1, for example at the upper portion 2 thereof, and/or the housing 100 of the device are in contact. Preferably, the distance between the frame 1 and the housing 100 of the device is selected by the plate 12 in a dimension, such that as less heat as possible is adsorbed from the frame 1 by the plate 2 and the housing 100 of the device.

Further, the device comprises a heating device 13 which continuously supplies heat to the building field environment or the building space there above. The term “building field environment” hereby designates an area which lies in the same plane as the building field 6 inside the housing 100 and laterally adjoins to the building field 6 and extends between the building field 6 and the housing 100. Preferably, the plate 12 is arranged in this building field environment, so that the heating device 13 then heats the plate 12 itself and/or the building space above the plate 12. The heating device 13 serves as active insulation of the building field 6, in order to compensate heat losses from the building field 6 outward into the building field environment and the building space there above. According to the first embodiment as shown in FIG. 1, the heating device 13 comprises at least one heat radiator which is preferably arranged above the plate 12. It is the purpose of this arrangement that a basic quantity of a heat amount is continuously supplied to the building field environment or the building space. Herein, it is not excluded that the heating device 13 supplies the heat also to other areas of the laser sintering device. However, it is essential for the invention that the heating device 13 continuously supplies the heat at least to the building field environment or the building space there above. The heat supply needed by the heating device 13 is determined on the basis of the building temperature, and it is preferably fixedly adjusted for devices for generatively manufacturing a three-dimensional object 3, wherein the devices are identical in construction. For example, fixed values for the used powders are provided, such as for building temperatures of 170° C., 180° C. and 190° C. The heating power of the heating device 13 can be changed during manufacturing the three-dimensional object 3, but preferably it is kept constant. The heating power of the heating device 13 is preferably not feedback-controlled. Preferably, the heating device 13 supplies more heat to the area of the building field environment close to the corners of the building field 6 than to other portions of the building field environment, since the heat loss is generally maximum at the corners of the building field 6. This can be achieved by positively focussing the heat radiation of the heating device 13 to the corners of the building field 6, or by arranging the heating device 13 close to the corners of the building field 6.

Furthermore, a further heating device 81, for example in the shape of linear heat radiators 81, is arranged in a predetermined distance to the building field 6 above the frame 1 and/or the building field 6. Such further heat radiators 81 are known from the prior art, such as from EP 0 764 079 B1. The further heat radiators 81 serve to heat-up the powdery layer, which has been applied by the coater 10, to a pre-temperature required for solidification by means of the laser beam 8′, wherein the heat radiators are usually discontinuously operated, that means, the heat supply to the building field is changed in time. At this time, each newly applied powdery layer is brought on the process temperature before the subsequent solidification by the laser.

The heating of the applied powdery layer is performed in the depicted embodiment by at least two, preferably four linear heat radiators 81 which are arranged according to FIG. 2 in adaptation to the shape of the frame 1 and/or the building field 6, which is defined by the same, preferably in the shape of a rectangle or a square in parallel to the building field 6. Each length of the individual heat radiators 81 approximately corresponds to the width of the building field 6 and/or the diameter of the building field 6 which is covered by it. The distance z of the heat radiator 81 to the building field 6 is for example 220 mm; however, this distance can be changed by a height adjustment device in adaptation to the peripheral conditions, so that in dependence of the adjusted heat current, a predetermined temperature can be obtained on the upper side of the applied powdery layer.

The heat radiators 13 can be arranged similar to the further heat radiators 81 corresponding to FIG. 2, wherein the heat radiators 13 form an outer ring around the heat radiators 81 which are arranged inside. The heat power of the heat radiators 13 is lower than the heat power of the further heat radiators 81. The heat radiators 13 supply less heat than the further heat radiators 81, so that the heat radiators 13 are remarkably smaller dimensioned than the further heat radiators 81.

The heat radiators 81 are preferably arranged above the building field 6 such that the axis of symmetry of the building field 6 coincides with the axis of symmetry of the radiator arrangement, that means, a square radiator arrangement is selected in a square building field 6, and a rectangular radiator arrangement is selected in a rectangular building field 6. The position of the heat radiators 81 is determined by calibration. The height z of the heat radiators 81 above the building field 6 and the angle of the heat radiators 81 to the building field 6 are manually adjusted at this time.

The heat radiators 81 are connected to a feedback-control means (not shown) for feedback-controlling the heat power of the heat radiators 81. This occurs by means of a sensor (not shown), such as a contactless measuring temperature detector in the shape of a pyrometer which is attached at a predetermined location above the powdery bed and/or the building field 6. To feedback-control the heat power of the heat radiator 81, for example an industrial feedback controller in the shape of a PID-controller or a PI-controller is used. The control path is a so-called PT1-element, wherein a predetermined sudden temperature change P is achieved with a delay T1. The feedback control of the heat radiators 81 is performed by a PID-controller. At this time, the control parameters are determined in a known manner by means of the response characteristic.

Since the heating device 13 is used in addition to the heat radiators 81, the heat radiators 81 must compensate less heat loss, so that the accuracy of the closed loop for the heat radiators 81 is improved compared with the prior art.

In operation of the device, the support 5 is lowered by the lift mechanics 4 in a first step, until the upper side thereof lies below the plane of the building field 6 by a desired thickness of a first powdery layer. Then, a first layer of the powdery material 11 is applied onto the support 5 by the coater 10 and smoothened.

This newly applied powder is cold powder from the storage container 10. The new powdery layer must be heated very quickly, so that the underneath layer is not strongly cooled down. Since the heat radiation emitted from the heat radiators 81 only heats the new powdery layer at the surface thereof, it takes a certain time until the whole powdery layer has been brought to the desired temperature by heat transport within the layer. For this purpose, the heat power of the heat radiator 81 is feedback-controlled by the PID-controller, for example.

Thereafter, the control unit 40 controls the deflection means 9 such that the deflected laser beam 8, 8′ selectively impacts to the locations of the layer of the powdery material 11 which shall be solidified. Thereby, the powdery material 11 is solidified and/or sintered at these locations, so that the three-dimensional object 3 is generated here.

In a next step, the support 5 is lowered by the lift mechanics 4 by the desired thickness of the next layer. A second powdery material layer is applied and smoothened by the coater 10 and selectively solidified by means of the laser beam 8, 8′. These steps are repeated until the desired object 3 is manufactured.

Advantageously, a continuous heat supply of the heating device 13 compensates the continuous heat loss, such that the heat losses at the periphery of the building field 6 can be minimized and a better temperature distribution is enabled up to the peripheral area. Thereby, the process-safe effective building field is enlarged. Thereby, homogenous heat supply and temperature distribution over the whole building field 6 can be achieved.

FIG. 3 shows a schematic view of a device for manufacturing a three-dimensional object according to a second embodiment of the present invention. In the second embodiment, the heating device comprises at least one resistance heater 14 which is arranged at the walls of the housing 100 either in a circumferential manner or in certain areas.

FIG. 4 shows a schematic view of a device for manufacturing a three-dimensional object according to a third embodiment of the present invention. In the third embodiment, the heating device comprises at least one resistance heater 16 which is arranged in or at the plate 12.

FIG. 5 shows a schematic view of a device for manufacturing a three-dimensional object according to a fourth embodiment of the present invention. In the fourth embodiment, the heating device comprises at least one heating mat 15 which is arranged in or at the plate 12.

The further construction and operation of the device of the second to fourth embodiments are the same of the first embodiment.

The device according to the invention is particularly applicable in laser sintering processes, in which the temperature of the uppermost powdery layer in the building field is pre-heated by the further heating device to few ° C. below the process temperature required for solidification, wherein the additional radiation by the laser beam 8′ provides a further application of energy to solidify the powdery material. This particularly applies in the use of powdery synthetic plastic material.

The scope of protection is not only restricted to the depicted embodiments, but it embraces further changes and modifications, provided that they fall within the scope as defined by the enclosed claims.

For example, the device according to the invention is not only applicable to laser sintering, but to all powder-based generative methods, in which a material and/or a powdery material is used in each applied layer which is solidified by energetic radiation. The energetic radiation has not necessarily to be a laser beam 8′, but it can also be an electron beam, or it can come from another light source than a laser, for example.

The heating device must not have to be formed by heat radiators, resistance heaters or heat mats. The heating device can be formed by a heating lamp or by an infrared radiator, for example. Further, it is also possible to let a heating fluid flow through areas of the plate 12 or the housing 100.

The heating devices 13, 14, 15, 16 of the first to fourth embodiments can be arbitrarily combined with each other.

1-10. (canceled)

11. A device for generatively manufacturing a three-dimensional object, comprising:
a frame, wherein the upper portion thereof surrounds a building field;
a support which is arranged in the frame and vertically movable at least below the building field by a lift mechanism;
a radiation device which generates an energy beam which is focussed to selected points in the building field by a deflection means, so as to selectively sinter or melt a powdery material which is present in the building field;
a coater for applying a layer of a powdery material onto the support or a previously applied layer of the powdery material;
a housing, in which at least the frame and the support are arranged and which surrounds a building space; and
a first heating device which continuously supplies heat at least to the building field environment or the building space there above.

12. The device according to claim 11, wherein a heat power of the first heating device is kept constant during manufacturing the three-dimensional object.

13. The device according to claim 11, wherein a second heating device is provided which serves to heat-up the powdery layer, which has been applied by the coater, on a pre-temperature required for sintering by means of the energy beam.

14. The device according to claim 13, wherein a heat power of the first heating device is less than that of the second heating device.

15. The device according to claim 11, wherein the first heating device comprises at least one device selected from the group consisting of a heat radiator, a resistance heater, a heating mat and a heat lamp.

16. The device according to claim 11, wherein the first heating device is arranged at walls of the housing either in a circumferential manner or in selected areas.

17. The device according to claim 11, further comprising a plate which is in contact with the frame and/or the housing of the device, wherein the first heating device continuously supplies heat to the plate.

18. The device according to claim 11, wherein the first heating device supplies more heat to corners of the building field than to other portions of the building field.

19. The device according to claim 11, wherein the frame is a replaceable frame, which is modularly insertable in and removable from the device.

20. A method for generatively manufacturing a three-dimensional object by use of a synthetic plastic powder as powdery material, said method comprising providing a device according to claim 11 and operating the device to manufacture the three-dimensional object.
